(19) United States
(12) Patent Application Publication
(10) Pub. No.: US 2016/0018544 A1
(43) Pub. Date: Jan. 21, 2016

(54) MARINE VIBRATOR DOPPLER CORRECTION

(71) Applicant: CONOCOPHILLIPS COMPANY, Houston, TX (US)

(72) Inventors: Peter M. EICK, Houston, TX (US); Joel D. BREWER, Houston, TX (US)

(21) Appl. No.: 14/800,780

(22) Filed: Jul. 16, 2015

Related U.S. Application Data
(60) Provisional application No. 62/025,565, filed on Jul. 17, 2014.

(51) Int. Cl. G01V 1/36; G01V 1/32; G01V 1/28; G01V 1/38

(52) U.S. Cl. CPC G01V 1/36; G01V 1/3808; G01V 1/32; G01V 1/282; G01V 2210/532; G01V 2210/40

(57) ABSTRACT

A method of processing seismic survey data includes: receiving seismic signatures emitted from a plurality of seismic sources during a frequency sweep as the sources are moved over a shot point; receiving a seismic trace generated by a seismic receiver, the seismic trace representing seismic signals resulting at least in part from the seismic signatures reflecting from an earth formation; performing an inversion of the seismic trace with the seismic signatures to separate the seismic trace into individual seismic signals, each of the individual seismic signals associated with a respective seismic source, wherein the inversion includes transforming the seismic trace to a frequency domain and generating frequency domain signals for multiple frequency bands in the frequency sweep; and during the inversion, applying a receiver motion correction to the frequency domain signals, and applying a Doppler correction to the frequency domain signals to correct for Doppler effects due to source motion.

### CROSS-REFERENCE TO RELATED APPLICATIONS

This application is a non-provisional application which claims benefit under 35 USC §119(e) to U.S. Provisional Application Ser. No. 62/025,565 filed Jul. 17, 2014, entitled “MARINE VIBRATOR DOPPLER CORRECTION,” which is incorporated herein in its entirety.

### FIELD OF THE INVENTION

This invention relates to systems and processes for seismic data acquisition and processing. In another aspect, the invention concerns processing seismic data acquired by a marine survey for analysis of earth formations. In another aspect, the invention concerns correcting seismic data for movement of seismic sources and/or seismic receivers.

### BACKGROUND OF THE INVENTION

Seismic reflection surveying is a technique that involves sending acoustic pulses into a subterranean formation and measuring reflected signals to image subsurface areas. Identification and imaging of subsurface areas is useful for hydrocarbon exploration.

Marine seismic surveys are conducted using marine seismic sources and recorders, e.g., using vessels that include or tow seismic sources and receivers. In some surveys, sweeps are conducted over various locations of an earth surface, during which variable frequency seismic signals are emitted from the sources as the sources travel over each location. Seismic energy reflected from a formation is detected and seismic data is analyzed to estimate properties of the formation. Analysis of such data is complicated data smear effects that are introduced into the data due to movement of the sources and/or receivers.

### SUMMARY OF THE INVENTION

An embodiment of a method of acquiring and processing marine seismic survey data. This method includes: receiving source data from a plurality of seismic sources, the source data representing seismic signatures emitted from the plurality of seismic sources during a survey time period during which a plurality of frequency sweeps are emitted as the sources are moved over a shot point. The method also includes receiving seismic data including seismic traces generated by a plurality of seismic receivers, the seismic traces representing seismic signals detected at the seismic receivers and resulting at least in part from the seismic signatures reflecting from an earth formation, and collecting a subset of the seismic data, the subset representing seismic signals detected at an assumed spatially invariant position during the survey time period. The method further includes performing an inversion of the subset with the seismic signatures to separate the subset into individual seismic signals, where each of the individual seismic signals are associated with a respective seismic source. The inversion includes transforming the seismic trace from a time domain to a frequency domain and generating frequency domain signals for multiple frequency bands in the frequency sweep. The method still further includes, during the inversion, applying a receiver motion correction to the frequency domain signals to correct for motion of the seismic receiver, and applying a Doppler correction to the frequency domain signals to correct for Doppler effects due to motion of the seismic sources.

Another embodiment is a system for acquiring and processing marine seismic survey data that includes a processing device configured to execute a seismic data processing program stored on a machine-readable medium. The processing device is configured to perform: receiving source data from a plurality of seismic sources, the source data representing seismic signatures emitted from the plurality of seismic sources during a survey time period during which a plurality of frequency sweeps are emitted as the sources are moved over a shot point. Seismic data including seismic traces generated by a plurality of seismic receivers is received, the seismic traces representing seismic signals detected at the seismic receivers and resulting at least in part from the seismic signatures reflecting from an earth formation. The processing device is also configured to collecting a subset of the seismic data, the subset representing seismic signals detected at an assumed spatially invariant position during the survey time period, and perform an inversion of the subset with the seismic signatures to separate the subset into individual seismic signals, each of the individual seismic signals associated with a respective seismic source, where the inversion includes transforming the subset from a time domain to a frequency domain and generating frequency domain signals for multiple frequency bands in the frequency sweep. The processing device is further configured to, during the inversion, apply a receiver motion correction to the frequency domain signals to correct for motion of the seismic receiver, and applying a Doppler correction to the frequency domain signals to correct for Doppler effects due to motion of the seismic sources.

A further embodiment of a method of acquiring and processing seismic survey data includes: towing a plurality of seismic sources and a plurality of seismic receivers by a marine vessel, and emitting a seismic signature from each of the plurality of seismic sources as the plurality of seismic sources are moved over a shot point at an earth formation, each of the seismic signatures having a frequency that varies over a selected period of time. The method also includes detecting seismic signals by the plurality of seismic receivers, the seismic signals resulting at least in part from the seismic signatures reflecting from the earth formation, and transmitting seismic traces representing the seismic signals to a processing device. The method further includes receiving, by the processing device, source data representing the seismic signatures and seismic data including the seismic traces, and collecting a subset of the seismic data, the subset representing seismic signals detected at an assumed spatially invariant position during the survey time period. The method still further includes performing an inversion of the subset with the seismic signatures to separate the subset into individual seismic signals, each of the individual seismic signals associated with a respective seismic source. Performing the inversion includes transforming the subset and the seismic signatures from a time domain to a frequency domain, convolving the transformed subset with the frequency domain seismic signatures and generating a frequency domain earth reflectivity model for each seismic source, the earth reflectivity model including a plurality of frequency slices corresponding to frequency bands within the frequency sweep. Performing the inversion also includes correcting the frequency domain earth reflectivity model by applying a Doppler correction function to each of the plurality of frequency slices, and applying a motion correction function to each of the plurality of frequency slices, and transforming the corrected frequency domain earth reflectivity model to the time domain to construct the time domain seismic signals associated with each seismic source.

### BRIEF DESCRIPTION OF THE DRAWINGS

The invention, together with further advantages thereof, may best be understood by reference to the following description taken in conjunction with the accompanying figures by way of example and not by way of limitation, in which:

FIG. 1 depicts an embodiment of a marine seismic data acquisition system;

FIG. 2 is a flow chart illustrating an embodiment of a method of acquiring and processing seismic data; and

FIG. 3 depicts an embodiment of a data processing and storage system for receiving and processing seismic data.

### DETAILED DESCRIPTION OF THE INVENTION

Apparatuses, systems and methods are provided for acquiring seismic data in, for example, a marine environment, and processing such data to evaluate earth formations. An embodiment of a seismic acquisition system includes a plurality of seismic sources (also referred to as a source array) and one or more seismic receivers configured to be towed by a marine vessel. The seismic sources are actuated by emitting seismic signals having frequencies that vary over a selected time period (referred to as a frequency sweep). The signals reflect from various subterranean locations and are detected by the one or more receivers on the streamer cable or receiving equipment.

In an embodiment of a data processing method, the seismic signatures emitted from the sources are collected and received by one or more recorders in the recording system. At the same time, the recording system is receiving seismic data in the form of a composite signal, made up of signals emitted from the sources, reflected from subsurface and subterranean locations, and detected by each of a plurality of receivers. When the source array is located at a first location or first “source point”, the sources are actuated to begin a first sweep, and the signatures and composite signal are received. At this first source point, the first source in the array is located at a specific physical position on the earth. As the vessel moves forward, the sources and receivers are also moving so at the next source point, the source array is now located such that when it begins actuation, the second seismic source is located in the physical position on the earth where the first seismic source was located at the first source point. The process continues for all of the seismic sources in the array.

In order to ensure that proper inversion can be performed on the received data, the individual seismic sources are configured to maintain the same phase, amplitude and frequencies swept from source actuation to the next source acquisition. Although the overall source array should emit the same signature at each source point, each of the individual seismic sources in the array emits a signature that is unique in terms of phase, frequency and amplitude relative the other individual sources. For example, each source operates over a variable phase, phase and frequency or phase, frequency and amplitude (or any combination of the above) sweep. The variations associated with each source must meet the criteria of sufficient uniqueness to allow proper separation during the inversion process.

Also while the vessel is moving forward, the receivers are also moving through the water. In one embodiment, in order to collect or process the seismic data into an invertible form, a subset of the seismic data is selected. The subset represents signals detected for each source point at an assumed spatially invariant position. A receiver position is selected (e.g., the position of the first receiver at the first shot point), and the subset is generated by collecting only the data from a receiver assumed to be located at the selected position at each source point. In this way, an assumed to be spatially invariant set of receivers is subset out of the seismic receiver data set. For example, at the first source point, a sorting algorithm shortens the receiver cable or receiving apparatus by the length of the source array in the far end, so in the sorting algorithm these channels are dropped off the end of the cable for the first source point. As the vessel moves forward to the second source point, the first receiver is dropped and one less than the length of the source array is dropped off the far end of the cables. This process proceeds until the all of the seismic sources have passed the source point. An invertible data set is thus created that meets the requirements of ZenSeis® or HFVS or similar phased based inversion approaches in that the receivers and the source point locations are relatively spatially invariant prior to inversion. This invertible data can now be input into an inversion process where the inversion is performed to separate the composite signal into individual signals, each of which represent seismic signals from a different source.

An embodiment of the inversion process includes transforming the signatures and the composite signal from the time domain to the frequency domain and convolving the signatures and the composite signals, and separating the signal into individual frequency bands. During the inversion process, each frequency band is further processed to correct for motion of the receiver during the frequency sweep, as well as the Doppler Effect due to motion of the sources over the shot point during the sweep. The mathematics for each of these corrections is well understood by those skilled in the art and will not be derived here.

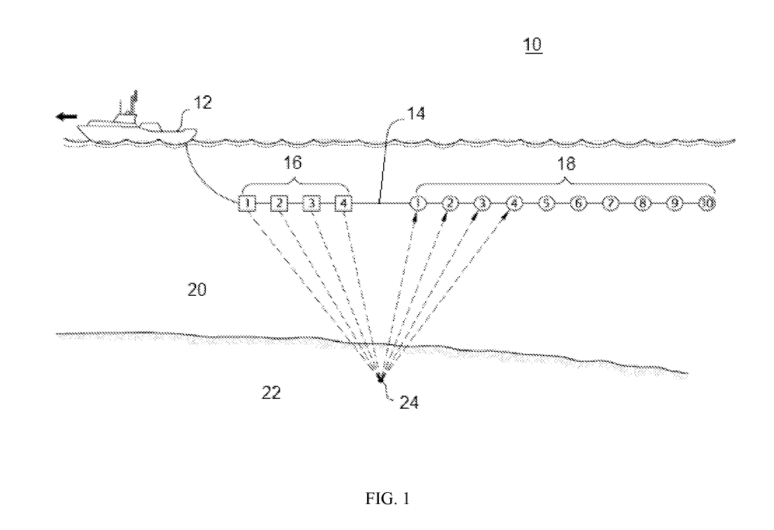

FIG. 1 illustrates an embodiment of a marine seismic measurement system 10. The system 10 includes a marine vessel 12 configured to tow one or more streamers 14, each of which are connected to one or more seismic sources 16 and seismic receivers 18. The seismic sources 16 may be any type of source capable of emitting acoustic energy sufficient to propagate through a body of water 20 and into a region of an earth formation 22. Exemplary seismic sources include air guns and/or marine vibrators, or similar sweepable marine type seismic sources. The seismic receivers 18 may include a suitable device capable of recording seismic signals reflected from the formation 22, such as hydrophones, accelerometers and others.

Multiple source/receiver combinations are used to generate seismic data, which may be combined to create a near continuous profile of the subsurface. For example, source 1 shown in FIG. 1 is actuated and measured by receiver 1, source 2 is actuated and measured by receiver 2, and so on. The seismic survey may be a two-dimensional (2D) survey in which the recording locations are generally laid out along a single straight line, or a three dimensional (3D) survey in which the recording locations are distributed across the surface above the formation in a systematic pattern.

The system 10 is utilized in performing a seismic survey to provide information regarding the formation. In one embodiment, a survey is performed by towing the sources 16 and the receivers behind the vessel 12. Seismic data is gathered by performing a series of “sweeps” over multiple locations on the formation surface. For each series of sweeps, a location or “shot point” 24 is selected. The sources 15 are actuated or swept at a shot point by each emitting a seismic signal over a period of time as the source moves over the shot point 24. The seismic signal (also referred to as a signature) has a varying or swept frequency over the time period. The receivers 18 detect the seismic signals that have reflected from various depths in the formation, and transmit or store the reflected signals for processing. Multiple sweeps (e.g., corresponding to the number of sources anchor receivers towed by the vessel) may be performed over a shot point during acquisition of a particular line or sequence.

One type of vibratory seismic data acquisition is referred to as high fidelity vibratory seismic (HFVS) or ZenSeis® surveying. In these methods, multiple two or more) seismic vibrators are operated simultaneously, thereby creating a complex source signal using various combinations of phase, frequency and amplitude encoding. In these applications, it is desirable to separate the contributions of each individual vibrator from the recorded composite signal in a multi-vibrator survey. To that end, the sweep signals of each vibrator can be varied in such a way as to make later separation feasible. One approach to this variation is to use “phase encodings” which, in simplest terms, involves the application of a constant phase shift to each vibrator's signal. That is, each vibrator generates an identical signal but the phase of each is shifted by a predetermined amount with respect to the others. Commonly in HFVS, these signals are orthogonal, such that each vibrator is encoding in some combination of 0, 90, 180, 270 degree rotations. ZenSeis®, on the other hand, uses generally non-orthogonal encodings that are optimally determined to achieve maximum separation and are commonly phase encodings that are prime numbers. Since the desired goal is maximum separation during the inversion process, it is desirable to create the most uniqueness around the seismic sources, so by using variable frequency and amplitude in addition to the varied phase one can increase the overall uniqueness and improve the precision of separation during the inversion process.

In one embodiment, the sweep emitted by each individual source remains the same at each source point, i.e., the sweep emitted from a source at one source point is the same as that emitted from that same source at every other source point during a particular line or sequence. In land type ZenSeis® or HFVS operations, the sources do not move from sweep to sweep and rotate through a set of phase encodings. However, in the marine environment the sources must move or they would be tangled, so the phase, amplitude frequency or any combination of them cannot change from sweep to sweep. If as an example the phase were to rotate from sweep to sweep for a particular seismic source, the data would not be cleanly invertible as the sources would lack uniqueness for clean separation. The data could be run through the inversion process, but the energy from each sweep of the non-cleanly separated seismic source would be distributed to the receiver traces Of all of the different source points that were included in the inversion. Thus the data would come out of the inversion step looking like normal seismic data with a multi-trace mix applied. Depending on how many elements in the source array, this may be an “acceptable” solution but it is not the optimal solution that could be achieved with the same hardware by making the attributes forming the uniqueness of the source invariant as it is moved from source point to source point.

Embodiments described herein, that include the steps of properly setting up the sources to be invariant, and properly collecting the data for inversion, are important for obtaining a clean inversion. In other embodiments these requirements could be relaxed with a progressive degradation in the separation of the traces and an introduction of more multi-trace smearing of the shot record traces.

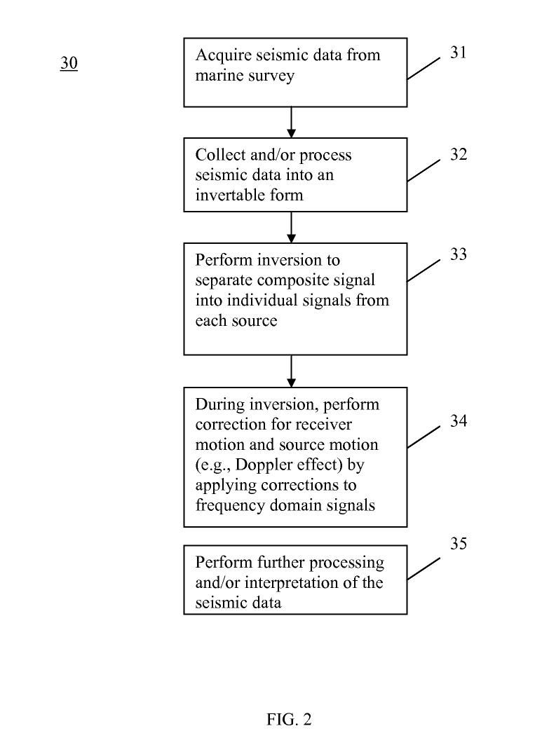

FIG. 2 is a flowchart depicting an exemplary method 30 of acquiring and/or processing seismic data. The method 30 may be performed on any suitable processor, processing device and/or network. For example, the method may be performed using suitable processing devices on the vessel 12 and/or other devices located onshore or at any desired location. The method 30 includes one or more stages 31-35, which may be performed in the order described. In other embodiment, one or more of the stages may be performed in a different order. In addition, some of the stages may be performed concurrently or simultaneously.

In the first stage 31, seismic data acquisition is performed. A marine vibrator or other seismic source (or a plurality of such sources) is towed or moved over a selected earth surface location (also referred to as a shot point). In one embodiment, a plurality of vibrators or sources (also referred to as a source array) are actuated and swept through a desired band of vibration frequencies over a selected time period as the vibrators move over the selected shot point using the appropriate phase, amplitude and frequency variations to achieve maximum separability. In one embodiment, the number of seismic receivers is at least equal to the number of seismic sources in order to make the data invertible. In other embodiments, one or more seismic receivers record seismic waves that have reflected from various depths and locations in an earth formation around the shot point. Seismic data generated by the receiver or receivers in response to detecting the reflected waves (referred to herein as reflected or recorded signals) are stored and/or transmitted (e.g., via transmission cable in a streamer) to a storage location or processing device.

The signals emitted by the sources are referred to as “sweeps”, as the vibratory frequency of each emitted signal is swept from a starting frequency to an ending frequency over a time period (typically several seconds). Although many sweep patterns may be used, a common pattern is a “linear” sweep Which is designed to vary between two frequency limits (e.g., between 5 Hz and 150 Hz) over a predetermined period of time. The amplitude of the sweep signal might either be fixed or frequency dependent, depending on a number of factors, like the need to improve the invertibility or uniqueness of the data.

In one embodiment, as the sources and receivers are moved through a body of water, a series of periodic seismic sweeps are performed at different locations. An initial encoding (e.g., phase encoding) is set for each seismic source and not varied for the rest of the acquisition of that particular line or sequence. An initial sweep is commenced by simultaneously or asynchronously exciting a plurality of the seismic sources to transmit encoded wave energy into the water. Subsequent sweeps are repeated at the appropriate distance apart until the line or sequence is completed and then the data is collected for inversion. In one example, the acquisition is performed as a ZenSeis® or HFVS survey, in which two or more (e.g., four) seismic vibrators are operated simultaneously using the same pilot signal, but with each phase of the generator signal used to drive each vibrator being phase shifted by a predetermined constant amount, (a, relative to the others.

Data is gathered for the sources and the receivers via one or more seismic recorders. The source data representing the source signals is gathered by, for example, measuring the pilot signals sent to the sources or by making actual measurements of the signals emitted from each source. The source data can be gathered by, for example, a recorder located proximate to each source. The receiver data also referred to as seismic data) is gathered by recording the seismic signals detected by each receiver. The gathered source and receiver data may be transmitted for real-time processing and/or recorded for later processing.

In one embodiment, the data is gathered using a system that includes an equal number of seismic sources and receivers. In order to achieve maximum separation, the seismic sources are separated by a distance (in the direction that the sources and receivers are moved during acquisition), such that each source is separated from an adjacent source by the same distance. The receivers are also separated such that each receiver is separated from adjacent receivers by the same distance as the distance between adjacent sources. The separation of the sources is thus equal to the separation of the receivers. In this way, the seismic data collected is naturally invertible without requiring pre-interpolation.

For example, as the vessel moves forward, the sources are simultaneously actuated to emit a seismic signal (the first actuation or first sweep) over a shot point. When the first sweep is performed, a first source and a first receiver are located at specific physical positions relative to the shot point. The vessel, sources and receivers continue moving forward, so at the time of the second sweep, the source array is now located such that when it begins the second sweep, a second seismic source is located in the physical position on the earth where the first seismic source was located.

At the second actuation, for the proper inversion of the data, the sources emit the same composite seismic signal. That is, each source maintains the same phase, amplitude and frequencies swept from the beginning of the first actuation. There is no “phase rotation” or variation in the operation of a seismic source from source point to source point. Thus, at each progressive sweep, the source array is actuated and operated with the same parameters as the prior sweep. The process continues for all of the seismic sources in the array.

Although the sweep from each full source array is the same from actuation to actuation, each source within the array operates a sweep that is different and unique relative to the other sources. Each source in the array operates over a variable phase, phase and frequency or phase, frequency and amplitude (or any combination of the above) sweep. In one embodiment, these variations must meet the criteria of sufficient uniqueness to allow proper separation during the inversion process. If they are not sufficiently unique, then the signal will bleed between source points and a smearing will occur post inversion trace data. Exemplary variations and methods for generating unique signals or sweeps are described in U.S. Patent Publication No. 2012/0039150, which is commonly assigned, the contents of which are incorporated herein by reference.

In the second stage 32, the seismic data is collected and/or processed into an invertible form, which allows the seismic data to be inverted without pre-interpolation. An appropriate subset of the seismic data is selected for inversion. This subset includes signals measured by a receiver at each shot point, along with positional data indicating the positions of the sources and receivers at each sweep. The subset is selected so that for each sweep, the subset represents only the receiver that is located at a selected location. This selected location is assumed to be spatially invariant, i.e., the selected location is assumed to be the same for each sweep and source point.

During acquisition, the vessel and the receivers are moving through the water. To be invertible, an assumed to be spatially invariant set of receivers is subset out of the seismic receiver data set. For each actuation or sweep, a composite signal including the sweeps from the sources is measured by the receiver array, thus generating a data set representing signals detected by all of the receivers at that sweep. A sorting algorithm is employed that selects a subset of the data set that represents only the signal detected by the receiver that is located at the selected spatially invariant position.

For each source point, the receiver that is located at the spatially invariant position is selected, and data from the receiver channels located in front of and/or behind the selected receiver channel are removed from the data. Thus, for each source point, only signals detected at the spatially invariant position are considered.

For example, for the first shot point, the receiver cable or apparatus is computationally shortened by the length of the source array in the far end, so that the receiver channels located behind the first receiver are dropped off the end of the cable for the first source point. As the vessel moves forward to the second source point, the first receiver is dropped and one less than the length of the source array is dropped off the far end of the cables. This process proceeds until the all of the seismic sources have passed the source point. The data collected by this method forms an invertible data set because the data set represents the same number of sweeps and sources, and a consistent number of receivers that are generally spatially invariant at a particular point on the earth. This data can now be input into an inversion process where the inversion is performed to separate the composite signal into individual signals, each of which represent seismic signals from a different source.

In the third stage 33, the composite signal from the sweep is separated by inversion with the seismic source signatures, i.e., the encoded signals. The data received by the acquisition described above includes the signatures from each source and the signals measured by each receiver. The source signatures and the receiver data are typically represented as time-varying amplitude signals referred to as traces. A receiver trace is the data set for a receiver that results from the combined operation of all vibrators operating during a single sweep.

Inversion is performed on each receiver trace to separate the signals detected from each source. The inversion process results in individual traces associated with each source, representing the contribution from each source to the signal measured by a receiver. Inversion includes transforming the time domain signals to frequency (F-K) domain by a Fourier transform or other suitable operator.

Each source signature is used as a base function, and the frequency domain receiver signals are processed with the base functions to generate representative signals for each source. The result is inversely transformed back to the time domain to reconstruct the signal measured by a receiver for each source.

For example, data for a HFVS survey is recorded from a sweep of multiple sources over a shot point, e.g., two or more seismic vibrators are operated simultaneously using the same pilot signal, but with each pilot signal for a respective vibrator being phase shifted by a predetermined constant amount, q, relative to the other vibrators activated during the sweep. The data recorded during the survey by a receiver, during a number k of sweeps, can be represented mathematically according to the following convolutional model:

$${d}_{i} ( t ) = {\sum }_{j = 1}^{n} {g}_{ij} ( t ) ⊗ {m}_{j} ( t )$$

$$for$$

$$i = l , k .$$

where dᵢ(t) is a column vector that contains the recorded data for sweep i, i=1,k, (i.e., the data trace that resulted from the combined operation of all n vibrators during the ith sweep), mⱼ(t) is the generally unknown earth reflectivity model at vibrator j, gᵢⱼ(t) represents the signal (signature) generated by vibrator j during sweep i, and \textcircled{x} represents the convolution operator.

For a plurality (e.g., four) of vibrators and at least a same number k of sweeps, the matrix dᵢ(t) would have k columns and several thousand rows, the length of each row depending on the length of time recorded and the sample rate. For example, if a 27 second recording period is used at a sample rate of 1 ms, dᵢ(t) would preferably have 27,000 rows, one row for each time sample. Note also that gᵢⱼ(t) will be dependent on the phase encoding or, more generally, the functional form of the sweep signal that has been selected. Also note that, in one embodiment, there are more sweeps than vibrators so as to form an over determined system.

What is ultimately of interest is the earth reflectivity model M at each vibrator mⱼ(t). The following description is an example of the calculation of the model M.

Let the matrix d be defined as follows:

d=[d₁(t)d₂(t)Kdₖ(t)].

that is, d has as its column vectors the observed data from the k different sweeps. Then, let D be the column-wise complex Fourier transform of d, i.e., each column of d has been replaced by its complex Fourier transform matrix D. Of course, the Fourier transform is one of any number of orthonormal transformations that might be used at this step. For example. Walsh transforms, general wavelet transforms, etc., could be used instead. Further, let the matrix G be the 3-dimensional matrix that is formed from the sweep signals as follows:

$$g = [ \begin{matrix}{g}_{11} ( t ) & {g}_{12} ( t ) & L & {g}_{1 n} ( t ) \\ {g}_{21} ( t ) & {g}_{22} ( t ) & L & {g}_{2 n} ( t ) \\ M & M & & M \\ {g}_{ki} ( t ) & {g}_{k 2} ( t ) & L & {g}_{kn} ( t )\end{matrix} ] .$$

i.e., g is a 3-dimensional matrix that is of dimension (k,n,L), where L is the length of each sweep signal.

G is the discrete Fourier transform of g, i.e., g has been Fourier transformed in the L (i.e., “time”) direction. In the frequency domain, the convolutional equation can then be represented in matrix form as:

D(f)=G(f)M(f),

which expresses the interchangeability between time domain convolution and frequency domain multiplication. Note that D(f) is a row vector of D, wherein the row corresponds to samples at Fourier frequency f, and thus D has dimension (L,k). Similarly, G(f) is a k by n matrix that is created by taking a horizontal slice of G at Fourier frequency f. Finally, the unknown matrix M(f) is column vector of length n (number of vibrators) and represents a frequency slice mⱼ(f) of the Fourier-transformed reflectivity model data for each vibrator.

In one embodiment, as a next step, the generalized least-squares solution for M is calculated at each frequency f and can be represented in matrix form as:

(G^{H}G)M=G^{H}D.

Note that the dependence on the frequency f has been dropped for purposes of notational convenience in the previous equation and hereafter. One way to calculate this least-square solution is to use singular value decomposition (“SVD”) to factor G at each frequency:

G=USV^{H},

so that the generalized least-squares solution for M is:

M=(G^{H}G)⁻¹G_{H}D=VS⁻¹U^{H}D,

where U is a matrix of eigenvectors that span the data space, V is a matrix of eigenvectors that span the model space, S is an n by n diagonal matrix whose non-zero elements are called eigenvalues, and H is a conjugate transpose operator.

M is calculated at each frequency or frequency band according to the previous equation. An inverse transform is then applied to reconstruct the time-domain signals associated with each vibrator, i.e., mⱼ(t). A potential problem with just inverting the data at this point is that the motion of the receivers and sources during the time that the sources were firing has not been corrected for.

In the fourth stage 34, during the inversion process and prior to transforming the frequency-domain data to the time domain, the frequency domain data is corrected for receiver motion, and for source motion effects including Doppler shift effects. As discussed above, each frequency band can be dealt with independently and each trace is dealt with independently. In addition, because the sweep frequency at each time point during a sweep is known, the precise location of the sources and receivers at each frequency is known so that the geometry of the source-receiver pathways is resolved at each frequency. Thus, the movement of the receivers and the sources can be accounted for by correcting for the receiver motion and Doppler shift by applying suitable equations or functions to individual frequency bands during the inversion process. Such equations may be empirically or heuristically derived to correct for spatial smear due to the Doppler Effect and for the movement of the receivers during a sweep. Exemplary methods of correction of Doppler Shift and receiver motion correction are described in U.S. Pat. Nos. 6,151,556 and 4,809,235, the contents of which are incorporated herein by reference in their entirety.

In one embodiment, the individual frequency bands (e.g., frequency slices of the frequency domain earth reflectivity model) are corrected for spatial smear due to Doppler shift, i.e., the difference in frequency between a received and transmitted signal due to movement of the transmitter and/or receiver during the sweep.

In one embodiment, for a set of data in a frequency band, an operator is applied to correct for phase dispersion resulting from Doppler shifting of the transmitted signals, by computing a phase correcting operator in the F-K domain, and applying the operator to the set of data. For example, the phase correcting operator is convolved with the frequency band signals (e.g., M(f))

In this embodiment, the operator is a function of vessel speed (i.e., source and receiver speed) and time dip of the seismic signal. The operator is computed in the frequency or F-K domain, and then convolved with the individual frequency bands.

In addition to Doppler correction, the frequency domain signals are corrected for receiver motion. A suitable operator or equation is applied to each frequency band during the inversion to correct for movement of the receiver during a sweep.

In one embodiment, the receiver motion, or spatial shift, is corrected in the F-K domain by multiplying the individual frequency bands M(f) by an operator representing the spatial shift of the receiver. For example, the spatial shift in the time domain may be represented by a delta function δ=(r₀−uᵣt), where r₀ is the position of the receiver when the sweep begins, and uᵣ is the receiver speed. The Fourier transform of the delta function δ is ê(−i2πkuᵣt), where i represents the square root of −1 (an imaginary number), k represents the spatial frequency (also referred to as the wavenumber) and π is a known constant. Convolution in the time and space domains is equivalent to multiplication in the frequency domain. Thus, the delta function i calculated to counterbalance the spatial shift caused by the receiver motion can be represented in the frequency domain as the product of the Fourier transforms of the shot record and ê(−i2πkuᵣt):

P(f,k)·e^{-2πku}^{ᵣ}^{t}

where P(f, k) is the two-dimensional Fourier transform of the data trace and is a function of temporal frequency f and spatial frequency k.

For correction of receiver motion and Doppler shift, the operators or equations are applied to each frequency band individually. Thus, this stage is repeated for each separated frequency band.

It is noted that the above corrections are exemplary, and that corrections are not limited to the embodiments described herein. Any mathematical operations or functions that can be applied in the frequency domain to correct the individual source signals during inversion may be used.

In the fifth stage 35, after the receiver signals have been corrected and separated, additional processing is performed on the signals. Exemplary processing techniques include common midpoint (CMP) stacking and migration. The data is analyzed and interpreted to derive information about the formation.

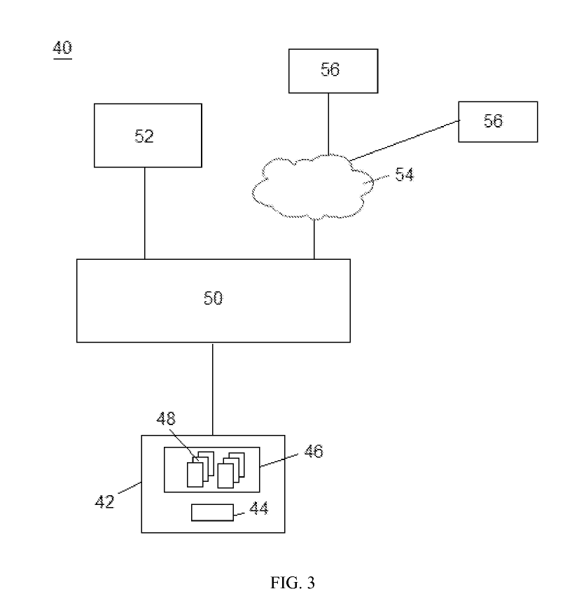

FIG. 3 refers to an embodiment of a seismic data processing system 40 that is configured to perform the methods described herein. The system 40 includes a processing device or unit 42 such as a computer (e.g., desktop or laptop). The processing unit 42 includes a processor 44 and a memory 46 that stores suitable algorithms, software and/or programs 48 for processing seismic data and/or analyzing subterranean formations. The processing unit 42 may be located at or with a seismic data acquisition system, e.g., located on the vessel 12, or located remotely. The processing unit 42 may be in communication with the sources 16 and receivers 18 to receive and process data in real time, or may access seismic data from a storage location. For example, the processing unit 42 may be connected to a host 50, which includes suitable processors, storage, input/output interfaces and other components for storing, transmitting and receiving seismic data, which can be received and stored from multiple surveys at multiple locations. The processing unit 42 and the host 50 are not limited to the configurations described herein, and may include any suitable device or network including various processors, memory and communications devices.

Seismic data that is processed by the processing unit 42 may be received from various databases or other storage devices 52, which can be internal or external to the host and/or processing unit. In addition, the host 50 and/or the processing unit 42 may be connected via the internet or other network 54 to various external sources 56 of data, e.g., databases or acquisition systems.

The embodiments described herein provide numerous advantages. The embodiments described herein provide accurate corrections to signals from marine vibrators or other moving seismic data acquisition systems. Acquisition techniques in which the sources and receivers are moving during a sweep provide operational efficiency, but have disadvantages due to such motion. The embodiments described herein allow for band limited corrections during inversion to correct for such motion, and thus address these disadvantages in a computationally efficient and time efficient manner.

Some prior art techniques utilize correction algorithms to correct for source and receiver motion. However, such techniques do not include processing or conditioning receiver data to allow for efficient inversion. For example, prior art techniques do not include collection of appropriate subsets of data from multiple sources to generate fixed station shot records, and thus require potentially complex interpolation calculations.

Embodiments described herein address such disadvantages by providing a method for selecting appropriate subsets for inversion from acquired seismic data. Such subsets represent data measured at an assumed spatially invariant position during an acquisition line or sequence, and allow for effective inversion without requiring pre-interpolation or other pre-processing.

Generally, some of the teachings herein are reduced to an algorithm that is stored on machine-readable media. The algorithm is implemented by the computer processing system and provides operators with desired output.

In support of the teachings herein, various analysis components may be used, including digital and/or analog systems. The digital and/or analog systems may be included, for example, in a processing device or system such as those described herein, e.g., the processing system 40 and/or processing device 42. The digital and/or analog systems may include components such as a processor, analog to digital converter, digital to analog converter, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The term “or” when used with a list of at least two items is intended to mean any item or combination of items.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of acquiring and processing marine seismic survey data, the method comprising:
receiving source data from a plurality of seismic sources, the source data representing seismic signatures emitted from the plurality of seismic sources during a survey time period during which a plurality of frequency sweeps are emitted as the sources are moved over a shot point;
receiving seismic data including seismic traces generated by a plurality of seismic receivers, the seismic traces representing seismic signals detected at the seismic receivers and resulting at least in part from the seismic signatures reflecting from an earth formation;
collecting a subset of the seismic data, the subset representing seismic signals detected at an assumed spatially invariant position during the survey time period;
performing an inversion of the subset with the seismic signatures to separate the subset into individual seismic signals, each of the individual seismic signals associated with a respective seismic source, wherein the inversion includes transforming the subset from a time domain to a frequency domain and generating frequency domain signals for multiple frequency bands in the frequency sweep; and
during the inversion, applying a receiver motion correction to the frequency domain signals to correct for motion of the seismic receiver, and applying a Doppler correction to the frequency domain signals to correct for Doppler effects due to motion of the seismic sources.

2. The method of claim 1, further comprising transforming the frequency signals to the time domain and constructing the individual seismic signals.

3. The method of claim 1, wherein the seismic signatures are emitted and the seismic signals are detected while the plurality of seismic sources are towed over the shot point by a marine vessel.

4. The method of claim 3, wherein the plurality of seismic sources are actuated at each frequency sweep to simultaneously emit the seismic signatures during the frequency sweep.

5. The method of claim 1, wherein collecting the subset includes collecting data from a sweep for a receiver of the plurality of seismic receivers, the receiver located at the assumed spatially invariant position at the time of the sweep, and excluding data from other seismic receivers not located at the assumed spatially invariant position at the time of the sweep.

6. The method of claim 1, wherein collection of the subset, the inversion, receiver motion correction and Doppler correction are performed in real-time during a marine seismic survey.

7. The method of claim 1, wherein performing the inversion includes transforming the seismic signatures of the subset to frequency domain source signals, and performing a convolution of the transformed seismic trace with the frequency domain source signals.

8. The method of claim 7, wherein performing the convolution includes generating a frequency domain earth reflectivity model for each seismic source, the earth reflectivity model including a plurality of frequency slices corresponding to frequency bands within the frequency sweep.

9. The method of claim 8, wherein applying the Doppler correction includes applying a Doppler correction function to each of the plurality of frequency slices, the Doppler correction function based on the speed of the seismic sources and the seismic receiver and the time dip of the seismic signals.

10. The method of claim 8, wherein applying the receiver motion correction includes applying a motion correction function to each of the plurality of frequency slices, the motion correction function based on the spatial shift of the seismic receiver during the frequency sweep.

11. A system for acquiring and processing marine seismic survey data, the system comprising:
a processing device configured to execute a seismic data processing program stored on a machine-readable medium, the processing device configured to perform:
receiving source data from a plurality of seismic sources, the source data representing seismic signatures emitted from the plurality of seismic sources during a survey time period during which a plurality of frequency sweeps are emitted as the sources are moved over a shot point;
receiving seismic data including seismic traces generated by a plurality of seismic receivers, the seismic traces representing seismic signals detected at the seismic receivers and resulting at least in part from the seismic signatures reflecting from an earth formation;
collecting a subset of the seismic data, the subset representing seismic signals detected at an assumed spatially invariant position during the survey time period;
performing an inversion of the subset with the seismic signatures to separate the subset into individual seismic signals, each of the individual seismic signals associated with a respective seismic source, wherein the inversion includes transforming the subset from a time domain to a frequency domain and generating frequency domain signals for multiple frequency bands in the frequency sweep; and
during the inversion, applying a receiver motion correction to the frequency domain signals to correct for motion of the seismic receiver, and applying a Doppler correction to the frequency domain signals to correct for Doppler effects due to motion of the seismic sources.

12. The system of claim 11, wherein the processing device is further configured to perform: transforming the frequency signals to the time domain and constructing the individual seismic signals.

13. The system of claim 11, wherein the seismic signatures are emitted and the seismic signals are detected while the plurality of seismic sources are towed over the shot point by a marine vessel.

14. The system of claim 11, wherein the plurality of seismic sources are actuated to simultaneously emit the seismic signatures during the frequency sweep.

15. The system of claim 14, wherein collecting the subset includes collecting data from a sweep for a receiver of the plurality of seismic receivers, the receiver located at the assumed spatially invariant position at the time of the sweep, and excluding data from other seismic receivers not located at the assumed spatially invariant position at the time of the sweep.

16. The system of claim 11, wherein performing the inversion includes transforming the seismic signatures of the subset to frequency domain source signals, and performing a convolution of the transformed seismic trace with the frequency domain source signals.

17. The system of claim 16, wherein performing the convolution includes generating a frequency domain earth reflectivity model for each seismic source, the earth reflectivity model including a plurality of frequency slices corresponding to frequency bands within the frequency sweep.

18. The system of claim 17, wherein applying the Doppler correction includes applying a Doppler correction function to each of the plurality of frequency slices, the Doppler correction function based on the speed of the seismic sources and the seismic receiver and the time dip of the seismic signals.

19. The system of claim 17, wherein applying the receiver motion correction includes applying a motion correction function to each of the plurality of frequency slices, the motion correction function based on the spatial shift of the seismic receiver during the frequency sweep.

20. A method of acquiring and processing seismic survey data, the method comprising:
towing a plurality of seismic sources and a plurality of seismic receivers by a marine vessel;
emitting a seismic signature from each of the plurality of seismic sources as the plurality of seismic sources are moved over a shot point at an earth formation, each of the seismic signatures having a frequency that varies over a selected period of time;
detecting seismic signals by the plurality of seismic receivers, the seismic signals resulting at least in part from the seismic signatures reflecting from the earth formation, and transmitting seismic traces representing the seismic signals to a processing device;
receiving, by the processing device, source data representing the seismic signatures and seismic data including the seismic traces;
collecting, by the processing device, a subset of the seismic data, the subset representing seismic signals detected at an assumed spatially invariant position during the survey time period; and
performing an inversion of the subset with the seismic signatures to separate the subset into individual seismic signals, each of the individual seismic signals associated with a respective seismic source, wherein performing the inversion includes:
transforming the subset and the seismic signatures from a time domain to a frequency domain,
convolving the transformed subset with the frequency domain seismic signatures and generating a frequency domain earth reflectivity model for each seismic source, the earth reflectivity model including a plurality of frequency slices corresponding to frequency bands within the frequency sweep,
correcting the frequency domain earth reflectivity model by applying a Doppler correction function to each of the plurality of frequency slices, and applying a motion correction function to each of the plurality of frequency slices, and
transforming the corrected frequency domain earth reflectivity model to the time domain to construct the time domain seismic signals associated with each seismic source.
